(19) United States
(12) Patent Application Publication
(10) Pub. No.: US 2009/0164278 A1
(43) Pub. Date: Jun. 25, 2009

(54) System for reducing risk of maintaining intellectual property

(76) Inventors: Peter L. Sewell, (US); David K. Young, Burke, VA (US)

Correspondence Address: COMPUTER PATENT ANNUITIES NORTH AMERICA, LLC;C/O CPA GLOBAL, P.O. BOX 52050, MINNEAPOLIS, MN, 55402, US

(21) Appl. No.: 12/003,288

(22) Filed: Dec. 21, 2007

(51) Int. Cl. G06F 17/00; G06Q 20/00

(52) U.S. Cl. 705/7; 705/35

(57) ABSTRACT

A system and method that reduces risks for law firms that are handle docketing and payment of renewals (also known as “annuity” or “maintenance”) fees on intellectual property such as patents and trademarks. The risk-reduction system is able to provide law firms an ability to exit the intellectual property annuities service business while mitigating risk to the firm. The structured program presents law firms with a process for seamlessly transitioning its clients (e.g., the patent-holders) from their firm to a service provider quickly and efficiently. The risk-reduction system has advantages of safely and efficiently assisting law firms with exiting the renewals business, mitigating the firm's risk, minimal or no disruption in service to the firm's clients, project planning with benchmarks for deliverables within a timeframe, and high service level service agreements signed directly between the firm's clients and a service provider.

### CROSS-REFERENCE TO RELATED APPLICATIONS

None

### FIELD OF THE INVENTION

The present invention relates to a system and method that reduces risks for law firms and corporations that are involved with the tracking and payment of renewal (also known as “annuity” or “maintenance”) fees on intellectual property such as patents and trademarks.

### BACKGROUND OF THE INVENTION

Businesses face a wide variety of risks, many that are due to events beyond their realistic control. Risks can be economic-based, technical-based, natural disasters, man-made disasters, and intrinsic risks to the business itself due to the product or service it provides. Insurance is typically purchased to compensate for some risks, but it cannot compensate for all risks. For example, if a semiconductor manufacturing company is located in northern California, it will plan for technical risks by the adoption of design and manufacturing expertise and qualify assurance practices, warranties from its suppliers, providing high degrees of technical skills by hiring experts in fields of technologies, increased research and development practices that are protected through procurement of intellectual property such as patents, copyrights, and trade secrets. It can hedge against economic risks by gaining contracts for future deliveries, by saving cash or investing, by balancing inventory and assets. It can hedge against natural disasters by locating in a building that has strong structural features to guard against damage by earthquakes.

Law firms and corporate legal departments are continually exposed to risks. For example, one type of risk a law firm confronts is a conflict-of-interest for representing competing corporations in a similar area of the law. Firms manage that risk by performing conflict-of-interest checks from each lawyer or department. Malpractice by an attorney represents another risk, both in law firms and in corporations.

Patent rights need to be maintained in all jurisdictions where they are registered. While maintaining renewals for a patent portfolio is essential to keep the rights of limited monopoly afforded by each patent, it can be time consuming and highly administrative, especially in more complex jurisdictions. A law firm or in house law group managing others' IP must assess the profit benefits against the risks associated with renewing a patent portfolio, since lapsing a patent could cause a loss of rights. This loss of rights cannot be recovered, as with a trademark, after certain procedural methods to restore the lapsed patent are exhausted. Loss of patent rights can potentially lead to loss of revenue and reputation, not to mention a possible legal battle.

Prior methods for performing patent and trademark renewals are to perform them in-house at a corporation, perform them at a law firm for the firm's clients, or hire an annuities provider that operates under the control of the law firm or corporation. Both methods require expenditure of resources including specialist staff with a continuity back-up plan of trained personnel in case the primary staff are no longer employed or otherwise cannot work. The renewals must be handled accurately and the data held securely on a reliable docketing and notification system. The legal requirements for each jurisdiction must be continually monitored and updated for changes in procedures and fees. Many jurisdictions require a local patent attorney to represent the patent holder in making payments, therefore a world-wide network of patent attorneys and agents in different time zones must be tracked and maintained.

The M.P.E.P. refers to 35 U.S.C. 41 Patent fees; patent and trademark search systems,” and states
“The Director shall charge the following fees for maintaining in force all patents based on applications filed on or after Dec. 12, 1980 (1) 3 years and 6 months after grant, $900, (2) 7 years and 6 months after grant, $2,300, (3) 11 years and 6 months after grant, $3,800. Unless payment of the applicable maintenance fee is received in the United States Patent and Trademark Office on or before the date the fee is due or within a grace period of 6 months thereafter, the patent will expire as of the end of such grace period. The Director may require the payment of a surcharge as a condition of accepting within such 6-month grace period the payment of an applicable maintenance fee. No fee may be established for maintaining a design or plant patent in force.

The risks faced by law departments themselves revolves around understanding and docketing patent maintenance fee payments. Docketing is the recording of critical information and events surrounding case management and prosecution of intellectual property rights. As attorney firms and companies have to keep track of deadlines and facts for thousands of patent and trademark filings worldwide, it is vital that the recording is timely and accurate, rendering it an essential part of any IP practice. The significantly higher liability of maintaining patents verses registered trademarks is because of the way rights are obtained for each type of property. Trademark rights are gained from their use, not from mere registration. Therefore a lapsed registration could be re-filed as a new application that claims use of the mark back to the original lapsed registration's claim of use. Patent rights, however, are gained through the grant of the patent, not through use of the invention. After a patent lapses due to failure to pay maintenance fees, it will enter into the public domain after which it cannot be re-instated.

Logistical problems with maintaining a trademark portfolio include a specialist staff trained in the area of trademark law, the ability to pay renewal fees in all currencies around the world, manage agent relationships in each country, and monitor each national law and procedure for paying. The administrative burden of trademark formalities can tax an already busy IP department.

Due to litigiousness of patent-holders and up to billion-dollar worth of the monopoly afforded products by patents, managing risk of maintaining patents is more important today than previously. Lawsuits caused by annuities management malpractice are on the rise, which is leading to an increasing number of firms wishing to remove themselves from the annuities business. One insurance carrier estimates that five percent of IP related claims are caused by annuities malpractice.

For a law firm, there are many challenges in transitioning out of the annuities business for its clients. Risks include annuities lapse risk, data integrity risk, and project planning and implementation risk.

To reduce the above-identified risks, what is needed is a risk-reduction system implemented through a service provider that can transition law firms out of the patent annuities service business successfully while mitigating risk to the law firm.

### SUMMARY OF THE INVENTION

The preferred and alternative embodiments of the present invention provide a method and system to implement risk management of docketing and paying patent maintenance fees to a nation's or region's patent office.

The risk-reduction system is able to provide law firms an ability to exit the intellectual property annuities service business while mitigating risk to the firm. The structured program presents law firms with a process for seamlessly transitioning its clients (e.g., the patent-holders) from their firm to a service provider quickly and efficiently. The risk-reduction system has advantages of safely and efficiently assisting law firms with exiting the renewals business, mitigating the firm's risk, minimal or no disruption in service to the firm's clients, project planning with benchmarks for deliverables within a timeframe, and high service level service agreements signed directly between the firm's clients and a service provider.

Renewals risk is mitigated by the system through a direct relationship between the service provider and the law firm. Data risk is mitigated through either a direct relationship between the service provider and the law firm to verify integrity of the law firm's annuities data. Project risk is mitigated through a project plan designed and implemented by the service provider and tracked by the software agent for benchmarks and timelines of deliverables.

A method and computerized system for reducing risk actually assumed by at least one of the parties is described, wherein at least one of the parties pays a patent maintenance fee for at least one of the other parties. If a payment of a maintenance fee that is due fails to occur, then at least one of the parties assumes the risk. A computer network can be made accessible with a network access device via a communications network for each of the parties involved in a renewals transaction. Executable software can be stored on a service provider's server, law firm server, and client computers that can be made executable on demand via the network access device.

### BRIEF DESCRIPTION OF THE DRAWINGS

For a better understanding of the nature of the present invention, its features and advantages, the subsequent detailed description is presented in connection with accompanying drawings in which:

FIG. 1 is a system of renewals in the prior art;

FIG. 2 is a network system capable of implementing the exemplary embodiments;

FIG. 3 is a high-level flowchart of a method of the exemplary embodiments;

FIG. 4 is a flowchart of preferred and alternative embodiments;

FIG. 5 is a matrix diagram of features of the preferred and alternative embodiments;

FIG. 6 is a flowchart of data verification of the preferred embodiment;

FIG. 7 is a flowchart of data verification decisions of the preferred embodiment;

FIG. 8 is a system diagram of the preferred embodiment illustrating removed responsibility of a law firm for managing renewals;

FIG. 9 is system diagram of an alternative embodiment illustrating partial responsibility of a law firm for managing renewals; and

FIG. 10 is system diagram of an alternative embodiment illustrating full responsibility of a law firm for managing renewals.

### DETAILED DESCRIPTION OF THE INVENTION

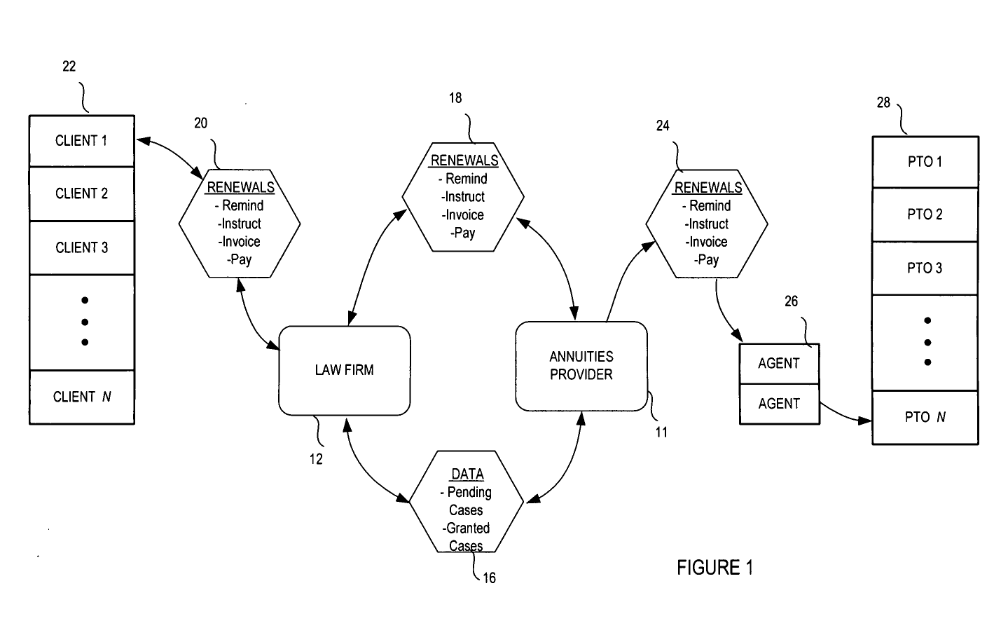

Referring to FIG. 1, a traditional system of managing intellectual property (e.g., patent and trademark) renewals that involve a law firm 10 instructing a service provider (SP) 14 for servicing the actual payment of renewals fees is illustrated. Law Firm 12 and SP 14 can either share a single database 16 containing pending cases and granted case or alternatively maintain separate databases. SP 14 issues one or more renewals reminder notices 18 to Law Firm 12 in advance of a renewal date. Law Firm 12 transmits a renewals notice to its own group of clients 22 who are the owners of pending and granted patent and trademark cases. The types of clients 22 include law firms, individual lawyers, a corporation, an individual inventor, a university, a partnership or intellectual property venture, each of which have a need or obligation to pay renewal (a.k.a. annuity or maintenance) fees on patents and trademarks owned by them or under their control. Clients 22 transmit pay instructions 20 back to Law Firm 12 which are then transmitted 18 on to SP 14. SP 14 transmits pay instructions 24 to one or more Agents 24, which are typically law firms having attorneys registered to practice before patent and trademark offices (PTO) 28. Agents 26 perform the actual payment of the case renewal to a PTO 28 and transmit an Invoice 24 which is paid by the SP 14. SP 14 transmits its own invoice 18 which is paid by Law Firm 12 which sends its own invoice 20 back to its clients 22 that pay the Law Firm's fees and services in addition to the SP 14 and Agent 26 fees within the invoice 20.

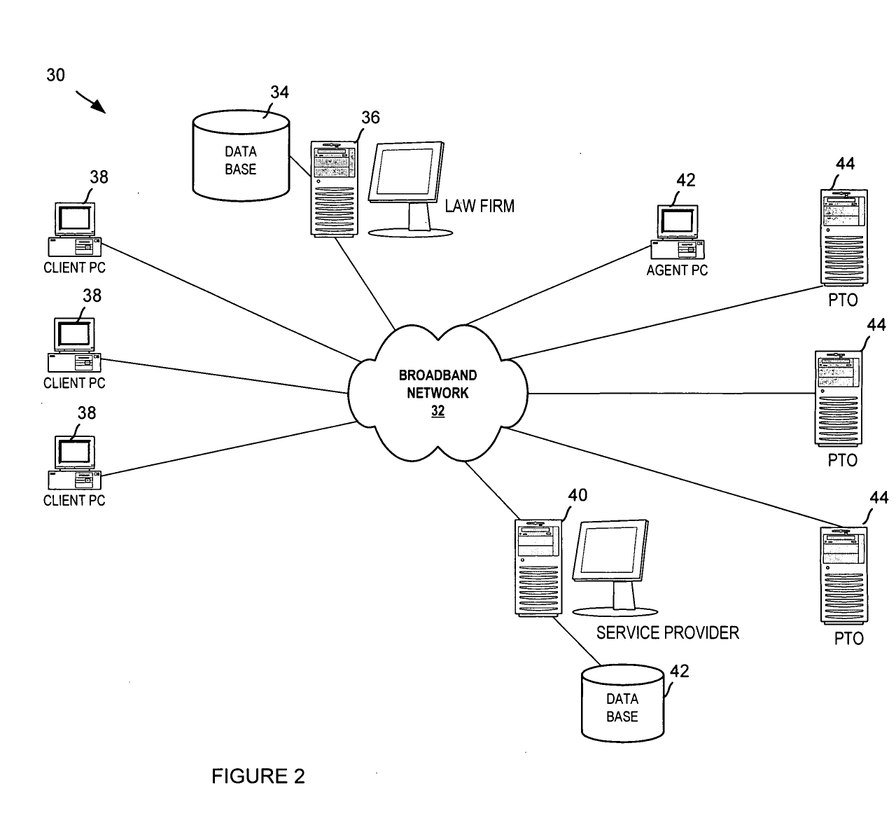

An embodiment of a computer network system 30 capable of implementing the preferred and alternative embodiments is illustrated in FIG. 2. All users and devices connect to broadband network 32, which can also include a packet-switched network such as the public Internet, managed network lines, and/or private wide area networks (WANs) as part of broadband network 32. Each server and end-user client computer on system 30 can connect to the broadband network 32 through a high speed network connection such as Ethernet LAN via a digital subscriber line (DSL), cable modem, or T1/T5 line. Law Firm server 36 connects to Law Firm's renewals database 34 holding its clients' case databases and is used by Law Firm 12 for activities related to its renewals system and services.

Clients 22 use end-user client computers 38 to connect with law firm server 36 via network 32. Each client user 38 may retain its own database containing its own intellectual property renewal case records. Service provider 14 uses Service Provider server 40 to access server 36, agent computer 42 and patent and trademark office servers 44 via network 32. SP server 40 contains it own intellectual property renewals database, which can contain similar client 22 renewals records as LF database 34 and PTO servers 44. The number of client computers 38, law firm databases 34, agent end-user computers 42, and PTO servers 44 connected to network 32 is up to the largest that will be supported by network system 30.

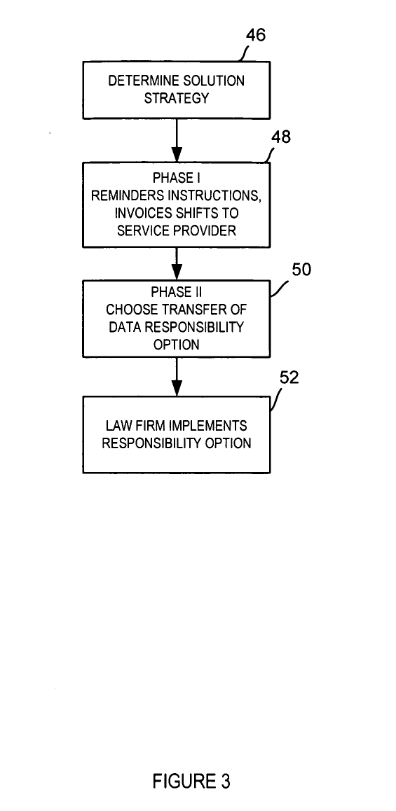

Referring now to FIG. 3, a flowchart of high-level steps of the exemplary embodiments is illustrated. The process begins by the Law Firm 12, together with the Service Provider 14 determining a solution strategy 46 that will allow the Firm to exit the renewals business and lower, or completely remove, risk associated with managing client renewals. The process involves two phases. In step 48 for Phase I, reminders instructions and invoices 18, 20 shifts to the SP 14 instead of Firm 12. In step 50, Phase II provides methods for the SP 14 to take over management of the renewals and the Firm 12 chooses an exemplary system that results from the transfer of data and renewals responsibility from the Firm to the SP 14. In step 52, the Firm 12 and SP 14 implement a system for transfer of responsibility.

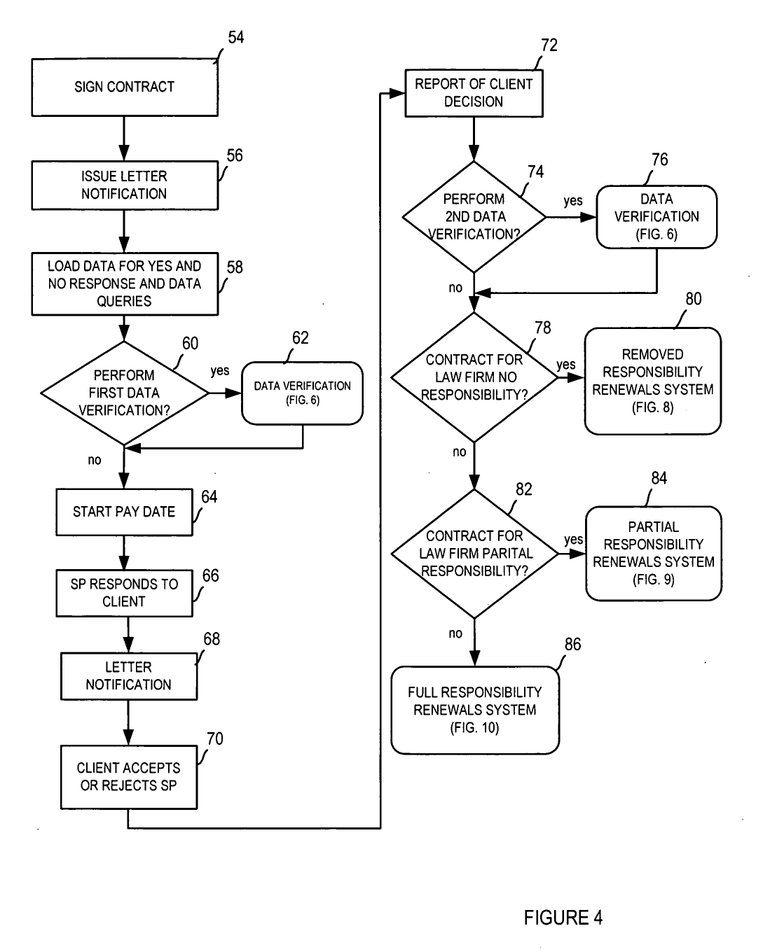

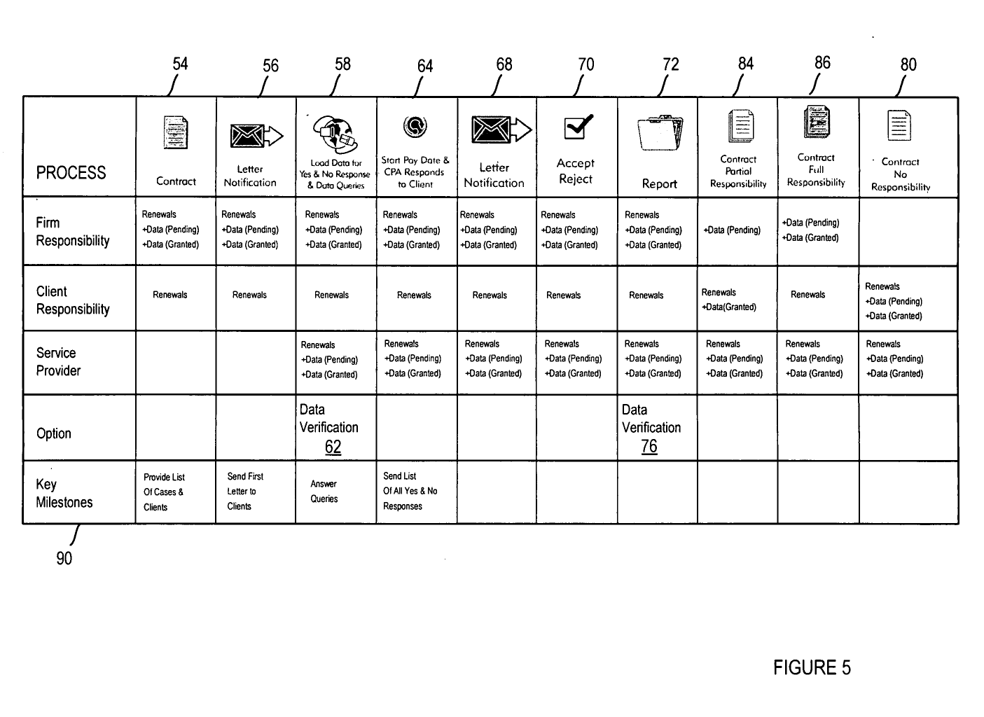

FIG. 4 illustrates the preferred embodiment of a process for Phases I and 11 of transferring responsibility of management of renewals. The matrix in FIG. 5 provides a summary of intersecting responsibilities and milestones between Firm 12, SP 14, and Client 22 during steps of the process in FIG. 4. During the entire process, client 22 always retains responsibility for its own intellectual property cases, since it is the owner of the case. Firm 12 retains responsibility of the data 16 for pending and granted cases up until a system implementation in steps 80 through 86. During the transition 48 and exit phases 50, there are certain risk factors that must be addressed. For example, understanding the origin and condition of the data that will generate renewal fee deadlines as part of the initial data transfer. Once the transition period is complete, a process will have to be implemented for the transfer of future cases to the service provider 14.

In step 54, a contract is between SP 14 and Law Firm 12. In the contract, terms can be provided for a partial or full indemnity of Law Firm 12 against any mistakes or oversights committed by SP 14 during the entire transition process and after the final management system is operational. For example, a risk of missing a reminding instruction for a renewal from SP 14 to client 22 can be taken on by the SP 14 through an indemnification of such risk during the contracting process 54. At this stage, key milestone 90 includes the Firm 12 providing SP 14 a list of renewals cases and its clients 22.

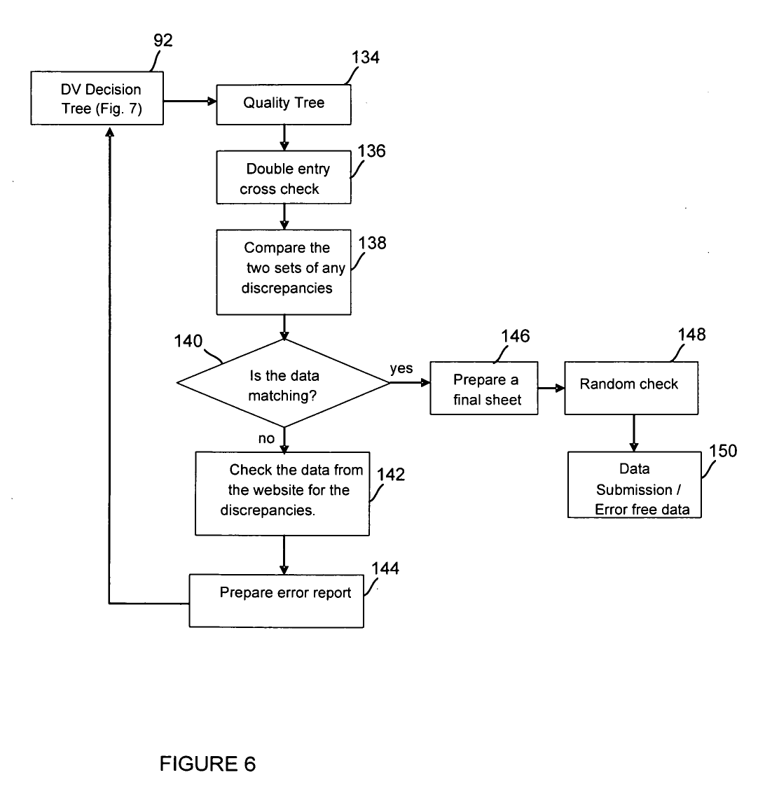

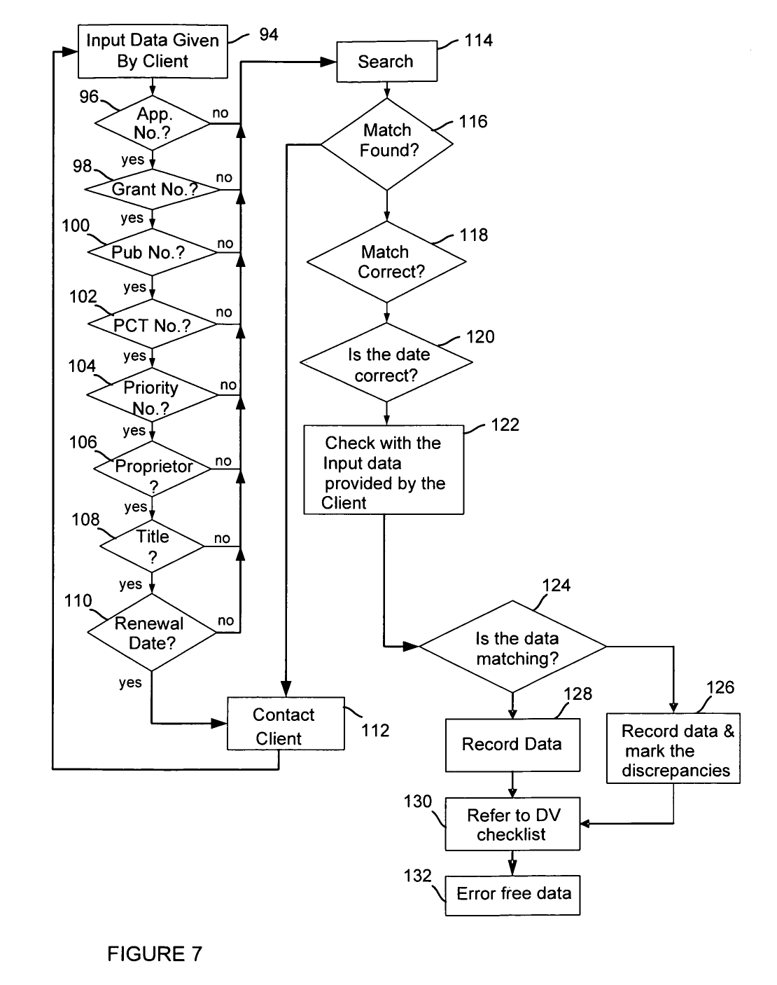

In step 56, a letter is sent from Firm 12 to each of its clients 22 notifying the client of the Firm's intention to exit the renewals business and turn responsibility over to SP 14, and querying the clients 22 of whether they desire transfer of their data to SP's responsibility. At step 58 the Firm's renewals data 16 is loaded for SP's management depending upon the yes or no responses to letter 56. At this stage, matrix in FIG. 5 illustrates that SP 14 has shared responsibility for live and granted case data along with Firm 12. The Firm 12 determines whether 60 it desires a first data verification of its renewals data by SP 14. If yes, then data verification is performed 62 according to the preferred process in FIGS. 6 and 7. At the time of transfer from law firm 12 to service provider 14, verifying critical patent data fields such as filing and grant dates, application and patent numbers, helps mitigate against an incorrect case and risk of lapsing due to data errors.

Referring to FIG. 6, data verification 62 begins with the DV Decision Tree 92 illustrated in FIG. 7. In step 94, the Firm 12 transfers data 16 to SP 14 for loading into SP's database 42. SP 14 verifies a number of fields in each record to ensure accuracy. Fields include an application number 96, a grant number 98, a publication number 100, a PCT number 102, a priority number 104, a proprietor or assignee 106, a title of the case 108, and a renewal date 110. If any field does not verify, in step 112 the SP 14 may contact the client 22 of a discrepancy or missing data and perform a search 114 for the case data on an official patent office server 44. If a record match is found 116 and the match is correct 118 and date is correct 120, then a verification check is performed 122 against original renewals case data held by client 22.

Further data that SP may verify includes a combination of the following data fields against public records with support from an agent 26 network:
Priority Number;
Priority Date;
Patent Co-operation Treaty Number;
Patent Co-operation Treaty Date;
Parent Application Number;
Parent Application;
Application Number;
Application Date;
Publication Number;
Publication Date
Grant Number;
Grant Date;
Proprietor;
Next Renewal Date;
Current Case Status;
Number of Claims (Japan, Philippines, Indonesia, South Korea only)
Number of Years (Spanish and Swiss supplementary protection certificates only)
Number of Designs (Austria, Benelux, Germany, Denmark, Finland, Iceland, South Korea, Malaysia, Norway, Poland, Portugal, Switzerland, Sweden and Morocco only).
   In addition, for data verification 62, clients 22 provide SP 14 with the following data:
Patent Number;
Priority Number;
PCT Filing Number;
Parent Application Number;
Application Number;
Publication Number;
Grant Number Proprietor; and
The number of cases involved.

If the searched data 114 is found matching to the input data 94 and client data in step 122, then the data is recorded 128. If a discrepancy exists, the data is recorded 126 and a mark is made of the discrepancy. After these steps are performed, the check list of steps 96 to 110 may be referred to again for additional interpretation of data discrepancies or verification. The final step 132 yields error-free data.

Referring again to FIG. 6, the DV process returns to step 134 for further verification through a quality tree. In step 136, any double entries in database 16 is cross-checked and the two sets of discrepancies are compared 138. If the data for the double entry is matching 140, a final format of the data is prepared 146. If the data is not matching 140, then discrepancies may be initially checked 142 against a PTO database 44, an error report prepared 144, and the data record returned to the DV decision tree 92 for re-processing. Once all data is confirmed, then a random check of data samples is performed 148, after which data is submitted in final form 150 that should be error free.

Referring again to the process in FIG. 4, the next step 64, whether or not data is verified 60, is to determine and begin a start pay date. The start pay date is the date on which SP 14 will begin to manage and pay renewals instead of Firm 12 and is the date when Firm 12 ceases to pay any renewal fees. In step 68, Firm 12 sends a letter notification to clients 22 with an explanation and request for queries concerning the new system for renewals. In step 70, the client 22 responds yes or no to whether it desires SP 14 to handle its renewals or whether it has chosen a different service provider or will handle renewals itself. If no response is received from a client 22, then an official notice is transmitted to that client stating its renewals will no longer be managed or paid by either Firm 12 or SP 14.

The next step 70 creates a report summarizing each client response from step 70. Here, Firm 12 decides 74 whether to perform a second data verification 76. Firm 12 can choose to have only on the cases from clients 22 that accept SP's management of its renewals based on the responses from step 70 or can perform the second verification on the entire renewals data set that was reviewed in step 62. Data verification 76 is handled the using the same preferred process in FIGS. 6 and 7 as discussed previously herein.

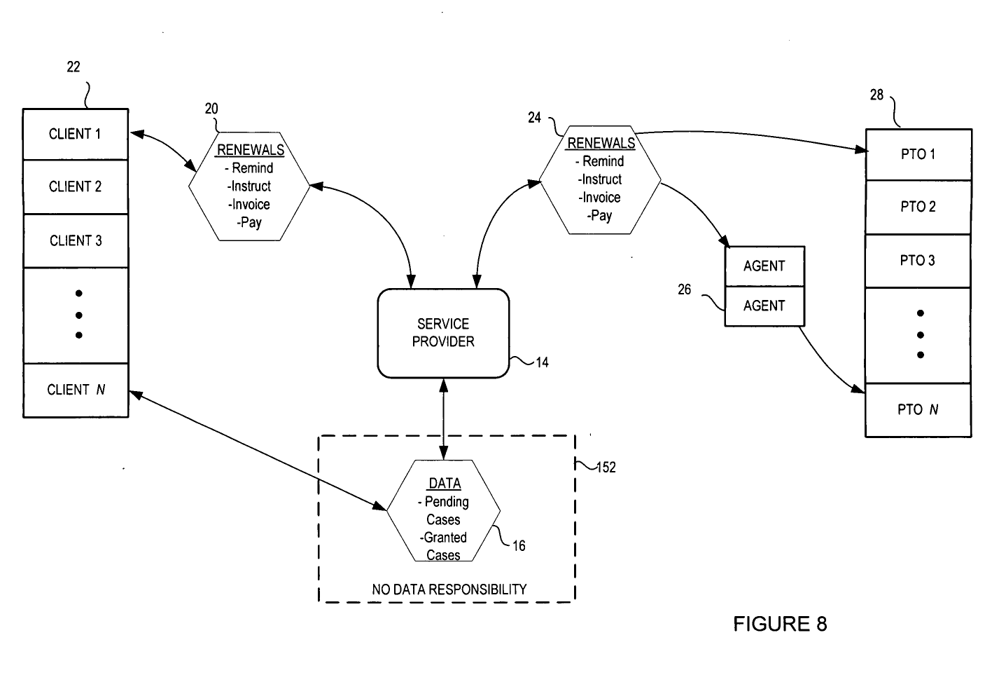

Phase II of the process begins at step 78, where the client 22 and Firm 14 contract with SP 14 for the type of renewals system to be implemented. In the preferred embodiment of step 78, Firm 12 decides whether it desires no responsibility for managing renewals. A no responsibility choice results in step 80 of removed responsibility for renewals, where the firm mitigates risk or is completely absolved of risk related to renewals management. FIG. 8 illustrates the preferred system for removed responsibility. Firm 12 retains no responsibility 152 for granted and pending renewals data 16 owned by client 22. SP 14 interacts directly with clients 22 for reminders, instructions, invoicing, and payments 20 of renewals instead of Firm 12. SP 14 interacts directly with agents 26 and PTOs 28 for reminders, instructions, invoicing and payments of renewals 24.

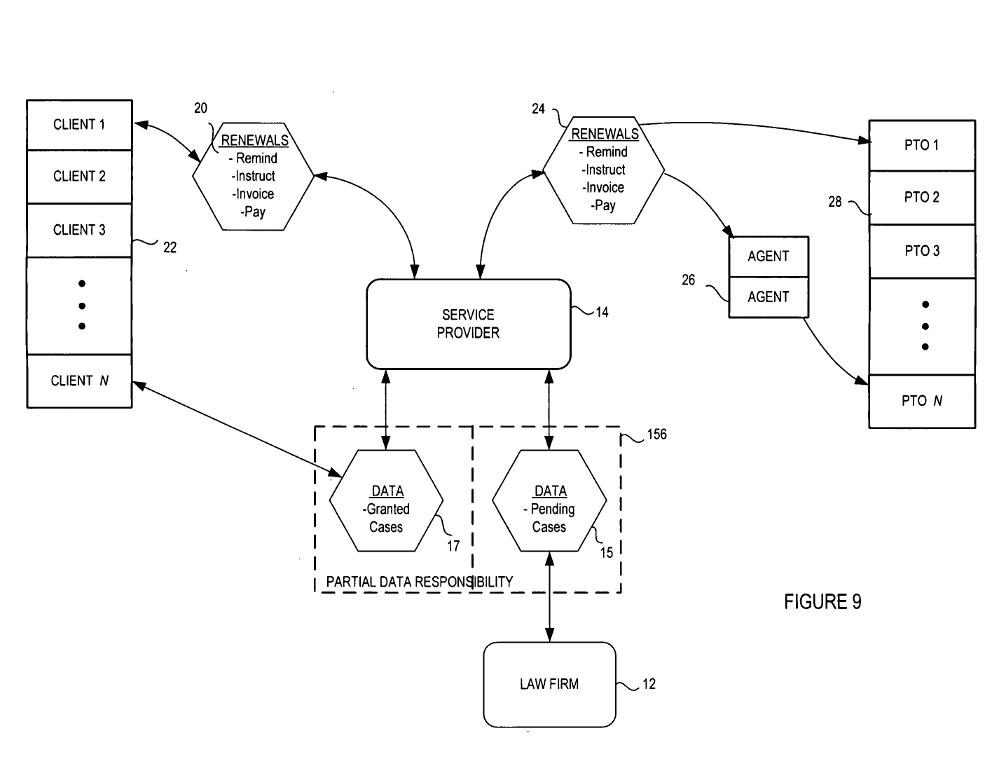

Step 82 is a decision whether Firm 12 desires to retain partial responsibility for client renewals resulting in step 84 and illustrated by the alternative embodiment for a renewals management system in FIG. 9. In the alternative embodiment, Firm retains responsibility 156 of renewals for pending client cases 15 but transfers responsibility for renewals of granted cases 17 to SP 14. For granted cases 17, SP 14 interacts directly with clients 22 for reminders, instructions, invoicing, and payments 20 of renewals instead of Firm 12. SP 14 interacts directly with agents 26 and PTOs 28 for reminders, instructions, invoicing and payments of renewals 24. For pending cases 15, Firm 12 instructs SP 14 to interact with clients 22 for reminders, instructions, invoicing, and payments 20 of renewals and instructs SP 14 to act directly with agents 26 and PTOs 28 for reminders, instructions, invoicing and payments of renewals 24.

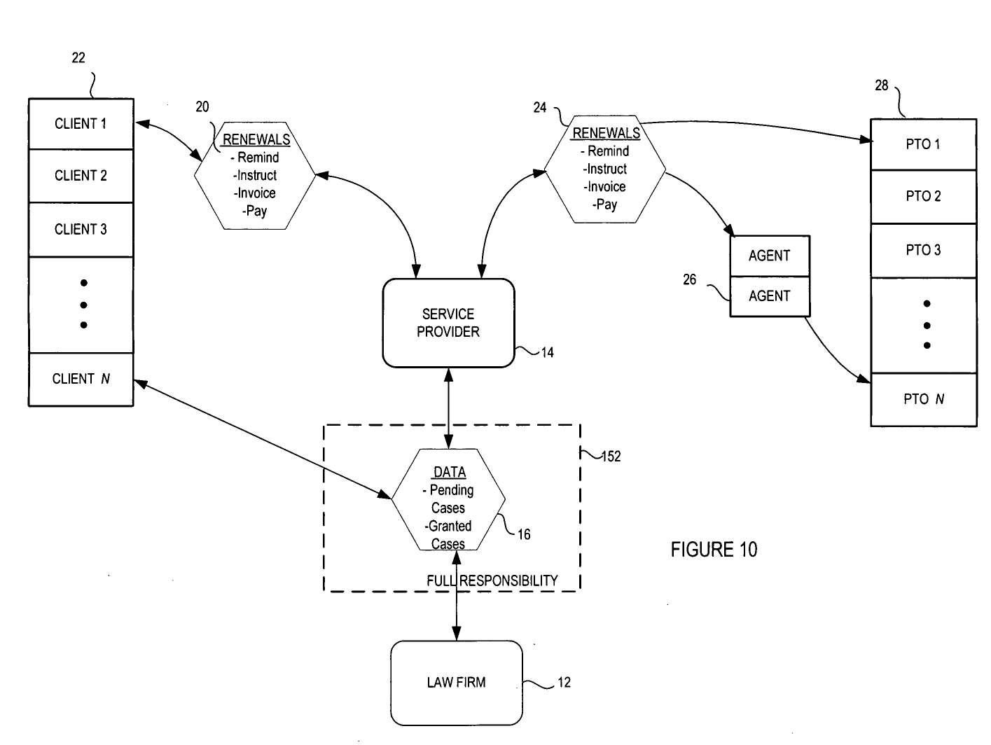

Referring again to FIG. 4, Firm 12 may decide in step 86 to retain full responsibility for managing renewals of both pending and granted cases for its clients. An additional alternative embodiment for a system of managing renewals under full Firm 12 responsibility is illustrated in FIG. 10. In this system, for pending and granted cases 16, Firm 12 instructs SP 14 to interact with clients 22 for reminders, instructions, invoicing, and payments 20 of renewals and instructs SP 14 to interact directly with agents 26 and PTOs 28 for reminders, instructions, invoicing and payments of renewals 24. This results in retention of high risk to Firm 12 for management responsibility, yet mitigates some risk by utilizing expertise of SP 14 and data verification 62, 76 of renewals data.

The present invention has the advantages of mitigating risk to a Firm for handling renewals for its clients. Through implementation of the preferred embodiment for a renewals management system, data risk is transferred to clients 22 and SP 14 by establishing a direct relationship between client 22 and SP 14 for data management, and by the verification of case data by SP 14. Project risk is transferred away from Firm 12 to SP 14 by the management of both Phase I and II of the preferred processes. Indemnification of Firm 12 by SP 14 results in a full transfer of risk of renewals away from the Firm that is absorbed by SP 14.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A system for reducing risk of intellectual property renewals management, comprising:
an intellectual property database for storing data related to renewals information for granted cases and pending cases of intellectual property, the database comprising fields of data identifying specific intellectual property cases;
a client component that owns one or more of the intellectual property cases;
a law firm component, in communication with and working for the client component, that uses the database to transmit renewals information between the law firm component and the client component;
and a service provider component, in communication with the client component and the law firm component, wherein the law firm component transfers risk and responsibility for renewals of the cases to the service provider, comprising transmitting reminders for paying a renewal to the client component, receiving instructions for paying a renewal from the client component, submits invoices for services and fees to the client component, and pays renewals to a patent and trademark office (PTO) component.

2. The system of claim 1, wherein the law firm component transfers an entire risk and an entire responsibility for the renewals of the cases to the service provider component using an indemnity of the law firm by the service provider.

3. The system of claim 1, wherein the transfer of risk and responsibility comprises the service provider component initiating a start pay date that determines the date the service provider begins to make the payment of renewals to the PTO component.

4. The system of claim 1, wherein the transfer of risk and responsibility comprises a transfer of responsibility for granted cases from the law firm component to the service provider component and retaining risk and management of the live cases by the law firm component.

5. The system of claim 1, wherein the transfer of risk and responsibility comprises the service provider performing a first data verification on the database component comprising comparing fields of data for the cases with data extracted from the PTO component.

6. The system of claim 5, wherein the first data verification further comprises performing the first verification only on case data that is identified by the client component for transferring risk and responsibility of renewals management from the law firm component to the service provider component.

7. The system of claim 5, wherein the transfer of risk and responsibility further comprises the client component agreeing by contract to transfer the risk and management from the law firm component to the service provider component, and
the service provider component performing a second data verification on the database component, after completion of the contract to transfer.

8. The system of claim 1, wherein the transfer of risk and responsibility comprises issuing a letter notification to the client component of the transfer,
tracking a response from the client component resulting from the issuing the letter,
performing a first data verification on the database component,
initiating a start pay date for paying the renewals on the cases,
issuing an acceptance letter to the client component for accepting or rejecting the transfer to the service provider,
and reporting a client response to the acceptance letter.

9. The system of claim 8, wherein the transfer of risk and responsibility further comprises the law firm transferring all responsibility for the database component and for performing the renewals to the service provider for the cases accepted for transfer by the client component.

10. A method for reducing risk of intellectual property renewals management, comprising:
providing an intellectual property database for storing data related to renewals information for granted cases and pending cases of intellectual property, the database comprising fields of data identifying specific intellectual property cases;
providing a client that owns one or more of the intellectual property cases;
providing a law firm, in communication with and working for the client, that uses the database to transmit renewals information between the law firm and the client;
providing a service provider, in communication with the client and the law firm, wherein the law firm; and
transferring risk and responsibility for renewals of the cases to the service provider, comprising transmitting reminders for paying a renewal to the client component, receiving instructions for paying a renewal from the client, submits invoices for services and fees to the client component, and pays renewals to a patent and trademark office (PTO).

11. The method of claim 10, wherein the law firm transfers an entire risk and an entire responsibility for the renewals of the cases to the service provider using an indemnity of the law firm by the service provider.

12. The method of claim 10, wherein the transferring of risk and responsibility comprises the service provider initiating a start pay date that determines the date the service provider begins to make the payment of renewals to the PTO.

13. The method of claim 10, wherein the transferring of risk and management comprises a transfer of responsibility for granted cases from the law firm to the service provider and retaining risk and management of the live cases by the law firm.

14. The method of claim 10, wherein the transferring of risk and management comprises the service provider performing a first data verification on the database comprising comparing fields of data for the cases with data extracted from the PTO.

15. The method of claim 14, wherein the first data verification further comprises performing the first verification only on case data that is identified by the client for transferring risk and responsibility of renewals management from the law firm to the service provider.

16. The method of claim 14, wherein the transferring of risk and management further comprises the client agreeing by contract to transfer the risk and management from the law firm to the service provider, and
the service provider performing a second data verification on the database, after completion of the contract to transfer.

17. The method of claim 10, wherein the transferring of risk and management comprises issuing a letter notification to the client of the transfer,
tracking a response from the client resulting from the issuing the letter,
performing a first data verification on the database component,
initiating a start pay date for paying the renewals on the cases,
issuing an acceptance letter to the client for accepting or rejecting the transfer to the service provider, and
reporting a client response to the acceptance letter.

18. The method of claim 17, wherein the transferring of risk and management further comprises the law firm transferring all responsibility for the database and for performing the renewals to the service provider for the cases accepted for transfer by the client.
